(19) United States
(12) Patent Application Publication
(10) Pub. No.: US 2012/0222657 A1
(43) Pub. Date: Sep. 6, 2012

(54) EVAPORATIVE EMISSION CONTROL DEVICE FOR INTERNAL COMBUSTION ENGINE

(76) Inventors: Takayuki SANO, Okazaki-shi (JP); Hiroshi Ohizumi, Okazaki-shi (JP); Koyu Araki, Toyoake-shi (JP); Yasuo Kojima, Miyoshi-shi (JP); Tomohiro Ohhashi, Okazaki-shi (JP); Yoshihiro Omi, Okazaki-shi (JP)

(21) Appl. No.: 13/411,182

(22) Filed: Mar. 2, 2012

(30) Foreign Application Priority Data
Mar. 4, 2011 (JP) 2011-048025

(51) Int. Cl. F02M 33/02

(52) U.S. Cl. 123/520

(57) ABSTRACT

A canister shutoff valve has a canister connection port for communicating with a canister, a vapor line connection port connected to a vapor line, and a purge line connection port connected to a purge line. When the canister shutoff valve is de-energized and thus is open, the canister connection port, the vapor line connection port and the purge line connection port communicate with one another, allowing fuel evaporative gas to flow into and out of the canister. When the canister shutoff valve is energized and thus is closed, the canister connection port is blocked and only the vapor line connection port and the purge line connection port communicate with each other, thereby preventing the fuel evaporative gas from flowing into and out of the canister.

### BACKGROUND OF THE INVENTION

1. Field of the Invention

The present invention relates to a evaporative emission control device for an internal combustion engine, and more particularly, to adsorption control in conjunction with a canister that adsorbs a fuel evaporative gas produced in a hermetic fuel tank.

2. Description of the Related Art

Techniques for preventing a fuel evaporative gas produced within a fuel tank from being discharged to the atmosphere have conventionally been known, wherein a canister is provided for communication with the fuel tank, and a fuel tank shutoff valve is inserted in a passage communicating the fuel tank and the canister with each other. The fuel tank shutoff valve is controlled so as to hermetically shut off the fuel tank at times other than refueling, and to open during refueling to allow the fuel evaporative gas to flow toward the canister so that the fuel evaporative gas may be adsorbed by the canister.

If the fuel tank is kept hermetically shut off by the fuel tank shutoff valve, however, the pressure in the fuel tank occasionally increases to high pressure as the fuel in the fuel tank evaporates with rise in the outside air temperature.

Thus, in order to prevent such fuel evaporative gas from being released to the atmosphere during refueling, the fuel tank shutoff valve is opened upon detection of a refueling-demanding manipulation, and the fuel filler opening is forcedly kept closed until the pressure in the fuel tank becomes sufficiently low.

However, it takes a long time to lower the internal pressure of the fuel tank, requiring much time before the refueling can be started.

To cope with such a situation, a technique has been developed whereby, when the pressure in the fuel tank is high, the fuel tank shutoff valve is opened if the engine is operating and also if purging is under way so that the fuel evaporative gas in the fuel tank may be discharged into the intake passage of the engine without being adsorbed by the canister, thereby lowering the internal pressure of the fuel tank (Japanese Patent No. 4110932).

In the evaporative emission control device disclosed in the above patent, however, the fuel tank shutoff valve and a purge vacuum switching valve (purge control valve) that opens and closes a communication passage for guiding the fuel evaporative gas to the intake passage are controlled so as to simultaneously open and close during operation of the engine, in order to lower the pressure in the fuel tank. The purge control valve and the fuel tank shutoff valve are thus operated cooperatively with each other, but since the fuel evaporative gas to be discharged into the intake passage of the engine through the communication passage passes through the canister, part of the fuel evaporative gas is adsorbed by the canister, possibly decreasing the amount of fuel evaporative gas that can be adsorbed by the canister during refueling.

### SUMMARY OF THE INVENTION

An object of the present invention is to provide a evaporative emission control device for an internal combustion engine whereby the amount of fuel evaporative gas adsorbed by a canister can be reduced.

To achieve the object, the present invention provides a evaporative emission control device for an internal combustion engine, comprising: a communication passage connecting an intake passage of the engine and a fuel tank to each other; a canister configured to adsorb a fuel evaporative gas in the communication passage; a communication passage opening-and-closing unit configured to establish and block communication between the communication passage and the intake passage; a canister opening-and-closing unit configured to allow the canister to open into the communication passage and to shut off the canister; a tank opening-and-closing unit configured to allow the fuel tank to open into the communication passage and to shut off the fuel tank; and a pressure detector configured to detect an internal pressure of the fuel tank, wherein, when the internal pressure of the fuel tank becomes higher than or equal to a predetermined value, the canister is shut off by the canister opening-and-closing unit.

When the internal pressure of the fuel tank detected by the pressure detector becomes higher than or equal to the predetermined value, the canister opening-and-closing unit is switched to shut off the canister. Since the canister is already shut off when the internal pressure of the fuel tank is released, the fuel evaporative gas can be reliably prevented from contacting with activated carbon contained in the canister.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 illustrates a schematic configuration of a evaporative emission control device according to a first embodiment of the present invention;

FIG. 2A is an enlarged view of a part A in FIG. 1, illustrating an unoperated state of a canister shutoff valve;

FIG. 2B is an enlarged view of the part A in FIG. 1, illustrating an operated state of the canister shutoff valve;

FIG. 3 illustrates the operation of a purge control valve, a fuel tank shutoff valve and the canister shutoff valve according to the first embodiment of the present invention, together with change with time of the internal pressure of a fuel tank;

FIG. 4 illustrates the operation of the purge control valve, the fuel tank shutoff valve and the canister shutoff valve according to a second embodiment of the present invention, together with change with time of the internal pressure of the fuel tank;

FIG. 5 illustrates a schematic configuration of a evaporative emission control device according to a third embodiment of the present invention;

FIG. 6A is an enlarged view of a part A in FIG. 5, illustrating an unoperated state of a canister shutoff valve; and

FIG. 6B is an enlarged view of the part A in FIG. 5, illustrating an operated state of the canister shutoff valve.

### DETAILED DESCRIPTION OF THE INVENTION

Embodiments of the present invention will be described below with reference to the accompanying drawings.

### First Embodiment

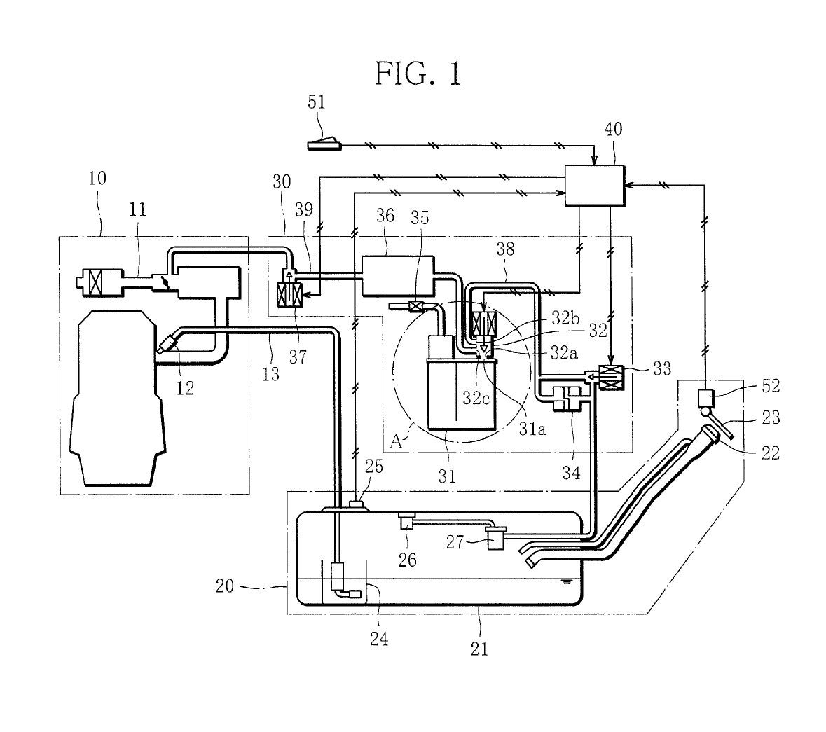

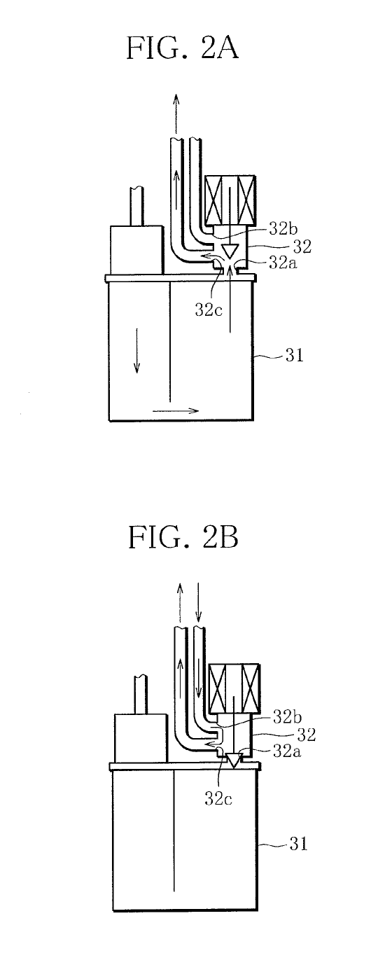

FIG. 1 schematically illustrates the configuration of a evaporative emission control device for an internal combustion chamber according to a first embodiment of the present invention. FIG. 2A is an enlarged view of a part A in FIG. 1 and illustrates an unoperated state of a canister shutoff valve 32, FIG. 2B is an enlarged view of the part A in FIG. 1 and illustrates an operated state of the canister shutoff valve 32, and in the figures, arrows indicate flowing directions of a fuel evaporative gas. In the following, the configuration of the evaporative emission control device for an internal combustion engine will be described.

As illustrated in FIGS. 1, 2A and 2B, the evaporative emission control device according to the first embodiment of the present invention generally comprises an engine (internal combustion engine) 10 mounted on a motor vehicle, a fuel storage section 20 for storing fuel, a fuel evaporative gas treatment section 30 for treating a fuel evaporative gas evaporated in the fuel storage section 20, an electronic control unit (hereinafter referred to as ECU) 40 configured to perform integrated control of the vehicle and including input/output devices, storage devices (ROM, RAM, nonvolatile RAM, etc.), a central processing unit (CPU) and the like, a fuel filler lid open/close switch 51 operated to open and close a fuel filler lid 23 of the vehicle, and a fuel filler lid sensor 52 for detecting the opened/closed state of the fuel filler lid 23.

The engine 10 is an MPI (Multi Point Injection) four-cycle in-line four-cylinder gasoline engine. The engine 10 has an intake passage 11 for supplying air to the interior of each combustion chamber of the engine 10. Fuel injection nozzles 12 are arranged on a downstream side of the intake passage 11 to inject fuel into respective intake ports of the engine 10. Each fuel injection nozzle 12 is connected with a fuel line 13 to be supplied with the fuel.

The fuel storage section 20 includes a fuel tank 21 storing the fuel, a fuel filler opening 22 through which fuel is poured into the fuel tank 21, the fuel filler lid 23 which is a lid for the fuel filler opening 22 formed in the body of the vehicle, a fuel pump 24 for supplying fuel from the fuel tank 21 to the fuel injection nozzles 12 through the fuel line 13, a pressure sensor 25 for detecting the pressure in the fuel tank 21, a fuel cutoff valve 26 for preventing fuel from flowing out of the fuel tank 21 into the fuel evaporative gas treatment section 30, and a leveling valve 27 for controlling the level of the fuel in the fuel tank 21 during refueling. A fuel evaporative gas produced inside the fuel tank 21 is discharged from the fuel cutoff valve 26 to the outside of the fuel tank 21 through the leveling valve 27.

The fuel evaporative gas treatment section 30 includes a canister 31, the canister shutoff valve (canister opening-and-closing unit) 32, a fuel tank shutoff valve (tank opening-and-closing unit) 33, a safety valve 34, an air filter 35, an evaporative gas reservoir 36, a purge control valve (communication passage opening-and-closing unit) 37, a vapor line (communication passage) 38, and a purge line (communication passage) 39.

The canister 31 has activated carbon contained therein. The canister 31 has an evaporative gas passage hole 31a through which the fuel evaporative gas produced within the fuel tank 21 flows in or the fuel evaporative gas adsorbed to the activated carbon flows out. Also, the canister 31 has an outside air inlet hole 31b through which outside air is introduced when the fuel evaporative gas adsorbed to the activated carbon is to be released. The air filter 35, which prevents entry of dust from outside, has one end opening to the atmosphere and the other end connected to the outside air inlet hole 31b.

The canister shutoff valve 32 has a canister connection port 32a for communicating with the evaporative gas passage hole 31a of the canister 31. The canister shutoff valve 32 has a vapor line connection port 32b communicating with the vapor line 38, of which one end is connected to the leveling valve 27 of the fuel tank 21 and the other end is connected to the vapor line connection port 32b, and also has a purge line connection port 32c communicating with the purge line 39, of which one end is connected to the intake passage 11 of the engine 10 and the other end is connected to the purge line connection port 32c. Thus, the canister shutoff valve 32 is connected through the vapor line connection port 32b to the vapor line 38 and is connected through the purge line connection port 32c to the purge line 39. The canister shutoff valve 32 is a normally open solenoid valve which opens when de-energized and which closes when energized with a drive signal externally supplied thereto. When the canister shutoff valve 32 is de-energized and thus is open as illustrated in FIG. 2A, the canister connection port 32a communicates with both of the vapor line connection port 32b and the purge line connection port 32c, allowing the fuel evaporative gas to flow into and out of the canister 31. On the other hand, when the canister shutoff valve 32 is energized with the drive signal externally supplied thereto and thus is closed as illustrated in FIG. 2B, the canister connection port 32a is blocked and only the vapor line connection port 32b and the purge line connection port 32c communicate with each other, so that the fuel evaporative gas is prevented from flowing into and out of the canister 31. That is, the canister shutoff valve 32 shuts off the canister 31 when closed, and opens up the canister 31 when opened.

The fuel tank shutoff valve 33 is inserted in the vapor line 38. The fuel tank shutoff valve 33 is a normally closed solenoid valve which closes when de-energized and which opens when energized with a drive signal externally supplied thereto. When the fuel tank shutoff valve 33 is de-energized and thus is closed, the vapor line 38 is blocked, and when the fuel tank shutoff valve 33 is energized with the drive signal externally supplied thereto and thus is open, the vapor line 38 is opened. That is, when the fuel tank shutoff valve 33 is closed, the fuel tank 21 is hermetically closed, thus preventing the fuel evaporative gas produced within the fuel tank 21 from flowing out of the fuel tank 21, and when the fuel tank shutoff valve 33 is opened, the fuel evaporative gas is allowed to flow out toward the canister 31.

The safety valve 34 is inserted in the vapor line 38 in parallel with the fuel tank shutoff valve 33. The safety valve 34 opens when the pressure in the fuel tank 21 rises above a certain level, to allow the internal pressure to escape to the canister 32 and thereby prevent breakage of the fuel tank 21.

The evaporative gas reservoir 36 is inserted in the purge line 39. The evaporative gas reservoir 36 serves to temporarily store the fuel evaporative gas flowing from the fuel tank 21.

The purge control valve 37 is inserted in a section of the purge line 39 between the intake passage 11 of the engine 10 and the evaporative gas reservoir 36. The purge control valve 37 is a normally closed solenoid valve which closes when de-energized and which opens when energized with a drive signal externally supplied thereto. When the purge control valve 37 is de-energized and thus is closed, the purge line 39 is blocked, and when the purge control valve 37 is energized with the drive signal externally supplied thereto and thus is open, the purge line 39 is opened. That is, when closed, the purge control valve 37 prevents the fuel evaporative gas from flowing from the fuel evaporative gas treatment section 30 toward the engine 10, and when opened, the purge control valve 37 allows the fuel evaporative gas to flow toward the engine 10.

The ECU 40 is a control device for performing integrated control of the vehicle and includes input/output devices, storage devices (ROM, RAM, nonvolatile RAM, etc.), a central processing unit (CPU), and timers.

The ECU 40 is connected at its input side with the pressure sensor 25, the fuel filler lid open/close switch 51 for opening and closing the fuel filler lid of the vehicle, and the fuel filler lid sensor 52 for detecting the opened/closed state of the fuel filler opening, to be input with information detected by the sensors.

Also, the ECU 40 is connected at its output side with the fuel injection nozzles 12, the fuel pump 24, the canister shutoff valve 32, the fuel tank shutoff valve 33, and the purge control valve 37.

Based on the information detected by the various sensors, the ECU 40 controls the opening/closing operation of the canister shutoff valve 32, the fuel tank shutoff valve 33 and the purge control valve 37, to control the pressure in the fuel tank 21.

In the first embodiment of the present invention configured as stated above, the pressure in the fuel tank 21 is controlled by the ECU 40 in the manner described below.

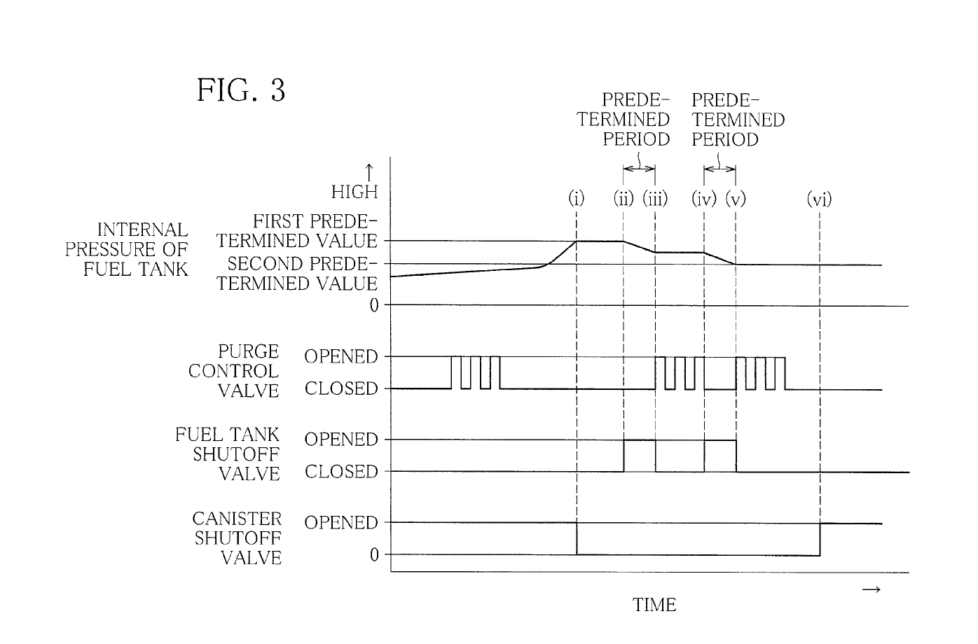

FIG. 3 illustrates the operation of the purge control valve 37, the fuel tank shutoff valve 33 and the canister shutoff valve 32, along with change with time of the internal pressure of the fuel tank.

As illustrated in FIG. 3, during operation of the engine 10, canister purge control is executed (up to time (i) in FIG. 3) wherein the opening/closing operation of the fuel tank shutoff valve 33 and the purge control valve 37 is controlled to supply the fuel evaporative gas, which has been adsorbed to the activated carbon in the canister 31 during refueling, to the engine 10 so that the fuel evaporative gas may be burned in the engine 10. During the canister purge control, the canister shutoff valve 32 is de-energized and thus is open.

When the detection value detected by the pressure sensor 25 and indicative of the internal pressure of the fuel tank 21 becomes greater than or equal to a first predetermined value (predetermined value), the drive signal is supplied to the canister shutoff valve 32 to energize same, with the result that the canister shutoff valve 33 is closed (at time (i) in FIG. 3).

After the canister shutoff valve 32 is closed, the drive signal is supplied to the fuel tank shutoff valve 33 to energize same so that the fuel tank shutoff valve 33 may be opened for a predetermined period to allow the fuel evaporative gas to flow out of the fuel tank 21. That is, the fuel tank shutoff valve 33 is opened (at time (ii) in FIG. 3) to allow the fuel evaporative gas to be introduced into a section of the purge line 39 up to the purge control valve 37 and the evaporative gas reservoir 36 without contacting with the activated carbon in the canister 31.

Then, after a lapse of the predetermined period, the supply of the drive signal to the fuel tank shutoff valve 33 is stopped to de-energize and thereby close the fuel tank shutoff valve 33, with the result that the fuel evaporative gas is prevented from flowing out of the fuel tank 21. Subsequently, the drive signal is supplied to the purge control valve 37 intermittently a predetermined number of times (in this embodiment, three times) so that the purge control valve 37 may be intermittently energized and thus be opened intermittently the predetermined number of times. That is, by intermittingly opening the purge control valve 37 the predetermined number of times, the fuel evaporative gas that has been introduced into the section of the purge line 39 up to the purge control valve 37 and the evaporative gas reservoir 36 is caused to be supplied to the engine 10 and burned there ((iii) in FIG. 3).

Subsequently, the supply of the drive signal to the purge control valve 37 is stopped to de-energize and thereby close the purge control valve 37. Then, the drive signal is supplied to the fuel tank shutoff valve 33 to energize and open the fuel tank shutoff valve 33 so that the fuel evaporative gas can flow out of the fuel tank 21 and be introduced into the section of the purge line 39 up to the purge control valve 37 and the evaporative gas reservoir 36 ((iv) in FIG. 3).

After a lapse of the predetermined period, the supply of the drive signal to the fuel tank shutoff valve 33 is stopped to de-energize and thereby close the fuel tank shutoff valve 33, with the result that the fuel evaporative gas is prevented from flowing out of the fuel tank 21. Then, the drive signal is supplied to the purge control valve 37 intermittently the predetermined number of times so that the purge control valve 37 may be intermittently energized and thus be opened intermittently the predetermined number of times. As a result, the fuel evaporative gas that has been introduced into the section of the purge line 39 up to the purge control valve 37 and the evaporative gas reservoir 36 is supplied to the engine 10 and burned there ((v) in FIG. 3).

Then, after the detection value detected by the pressure sensor 25 and indicative of the internal pressure of the fuel tank 21 becomes smaller than a second predetermined value and also after the intermittent opening operation of the purge control valve 37 is terminated, the supply of the drive signal to the canister shutoff valve 32 is stopped (at time (vi) in FIG. 3) to de-energize and thereby open the canister shutoff valve 32.

Thus, in the evaporative emission control device according to the first embodiment of the present invention, when the pressure in the fuel tank 21 becomes higher than or equal to the first predetermined value, the canister shutoff valve 32 is closed and then the fuel tank shutoff valve 33 is opened, in order to allow the fuel evaporative gas to be introduced into the section of the purge line 39 up to the purge control valve 37 and the evaporative gas reservoir 36. Then, after the fuel tank shutoff valve 33 is closed, the purge control valve 37 is intermittently opened the predetermined number of times, in order to cause the fuel evaporative gas that has been introduced into the section of the purge line 39 up to the purge control valve 37 and the evaporative gas reservoir 36 to be supplied to and burned in the engine 10. After the pressure in the fuel tank 21 becomes lower than the second predetermined value, the canister shutoff valve 32 is opened.

Since the fuel tank shutoff valve 33 or the purge control valve 37 is opened and closed to lower the internal pressure of the fuel tank 21 after the canister 31 is shut off by the canister shutoff valve 32, the fuel evaporative gas produced inside the fuel tank 21 does not contact with the activated carbon contained in the canister 31, whereby the amount of fuel evaporative gas adsorbed by the canister 31 can be suppressed.

Also, the opening operation of the fuel tank shutoff valve 33 and that of the purge control valve 37 are not cooperatively controlled but are controlled independently of each other, and therefore, the control procedure can be simplified.

Further, the evaporative gas reservoir 36 is inserted in the purge line 39 to temporarily store the fuel evaporative gas therein. Accordingly, a large amount of fuel evaporative gas can be efficiently discharged into the intake passage 11 of the engine 10 by a single opening-and-closing operation of the fuel tank shutoff valve 33 and the subsequent repeated opening-and-closing operation of the purge control valve 37.

### Second Embodiment

A evaporative emission control device for an internal combustion engine according to a second embodiment of the present invention will be now described.

The second embodiment differs from the first embodiment in the method of controlling the internal pressure of the fuel tank 21 by the ECU 40. Thus, in the following, the manner of how the internal pressure of the fuel tank 21 is controlled by the ECU 40 will be explained.

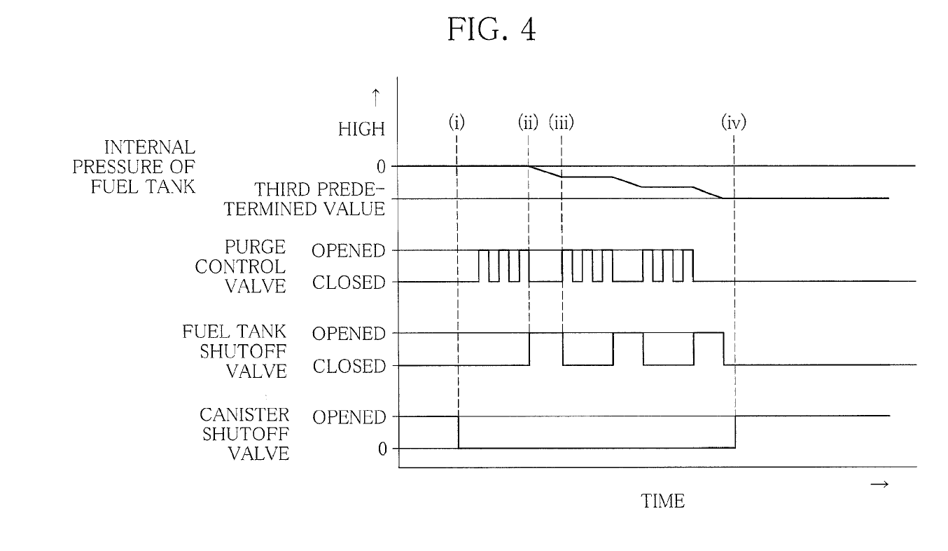

FIG. 4 illustrates the operation of the purge control valve 37, the fuel tank shutoff valve 33 and the canister shutoff valve 32 of the evaporative emission control device according to the second embodiment of the present invention, together with change with time of the internal pressure of the fuel tank.

As illustrated in FIG. 4, when the pressure in the fuel tank 21 is “0” during operation of the engine 10, the drive signal is supplied to the canister shutoff valve 32 to energize and thereby close the canister shutoff valve 32 (at time (i) in FIG. 4).

Subsequently, the drive signal is supplied to the purge control valve 37 intermittently a predetermined number of times (in this embodiment, three times) so that the purge control valve 37 may be intermittently energized and be opened intermittently the predetermined number of times, to connect the intake passage 11 of the engine 10 to a section of the vapor line 38 up to the fuel tank shutoff valve 33 through the purge line 39. Specifically, the purge control valve 37 is opened to allow the intake passage 11 of the engine 10 to communicate with the section of the vapor line 38 up to the fuel tank shutoff valve 33 through the purge line 39 and the evaporative gas reservoir 36 so that the fuel evaporative gas in the purge line 39, the evaporative gas reservoir 36 and the section of the vapor line 38 up to the fuel tank shutoff valve 33 may be drawn by intake-side negative pressure into the intake passage 11 of the engine 10 and that the intake-side negative pressure may prevail not only in the intake passage 11 of the engine 10 but in the purge line 39, the evaporative gas reservoir 36 and the section of the vapor line 38 up to the fuel tank shutoff valve 33 ((ii) in FIG. 4).

Then, the supply of the drive signal to the purge control valve 37 is stopped to de-energize and thereby close the purge control valve 37. Subsequently, the drive signal is supplied to the fuel tank shutoff valve 33 to energize and thereby open the fuel tank shutoff valve 33, thus allowing the fuel evaporative gas to flow out of the fuel tank 21. That is, the fuel tank shutoff valve 33 is opened to cause the fuel evaporative gas in the fuel tank 21 to be drawn by the negative pressure then prevailing in the section of the vapor line 38 up to the fuel tank shutoff valve 33, the purge line 39 and the evaporative gas reservoir 36, with the result that the negative pressure also prevails in the fuel tank ((iii) in FIG. 4).

The combination of the intermittent opening operation of the purge control valve 37 and the subsequent opening operation of the fuel tank shutoff valve 33 is executed a predetermined number of times (in this embodiment, three times), so that the pressure in the fuel tank 21 further lowers.

After the detection value detected by the pressure sensor 25 and indicative of the internal pressure of the fuel tank 21 becomes smaller than a third predetermined value and also after the fuel tank shutoff valve 33 is closed, the supply of the drive signal to the canister shutoff valve 32 is stopped to de-energize and thereby open the canister shutoff valve 32 (at time (iv) in FIG. 4).

Thus, in the evaporative emission control device according to the second embodiment of the present invention, the purge control valve 37 is intermittently opened the predetermined number of times after the canister shutoff valve 32 is closed, to allow the fuel evaporative gas in the purge line 39, the evaporative gas reservoir 36 and the section of the vapor line 38 up to the fuel tank shutoff valve 33 to be drawn into the intake passage 11 of the engine 10. As a result, the negative pressure prevails in the purge line 39, the evaporative gas reservoir 36 and the section of the vapor line 38 up to the fuel tank shutoff valve 33. Then, after the purge control valve 37 is closed, the fuel tank shutoff valve 33 is opened.

The purge control valve 37 is opened first, in order to lower the pressure in the fuel tank 21.

Also, the pressure in the fuel tank 21 is lowered step by step, and since the internal pressure difference between the vapor line 38 and the fuel tank 21 is small, it is possible to prevent the fuel from being drawn into the vapor line 38.

### Third Embodiment

A evaporative emission control device for an internal combustion engine according to a third embodiment of the present invention will be now described.

The third embodiment differs from the first embodiment in that a canister shutoff valve 32′ is used instead. In the following, the configuration of the fuel evaporative emission control device according to the third embodiment will be explained.

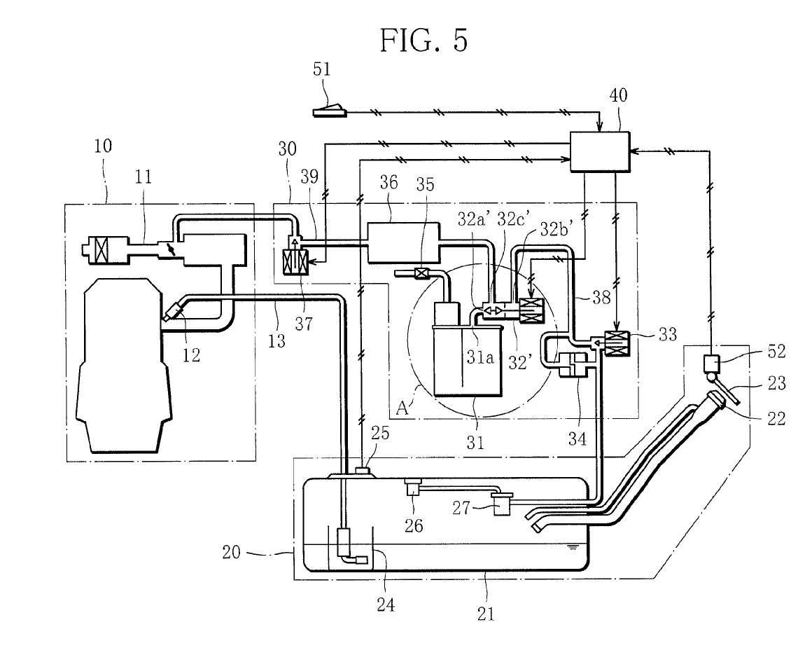

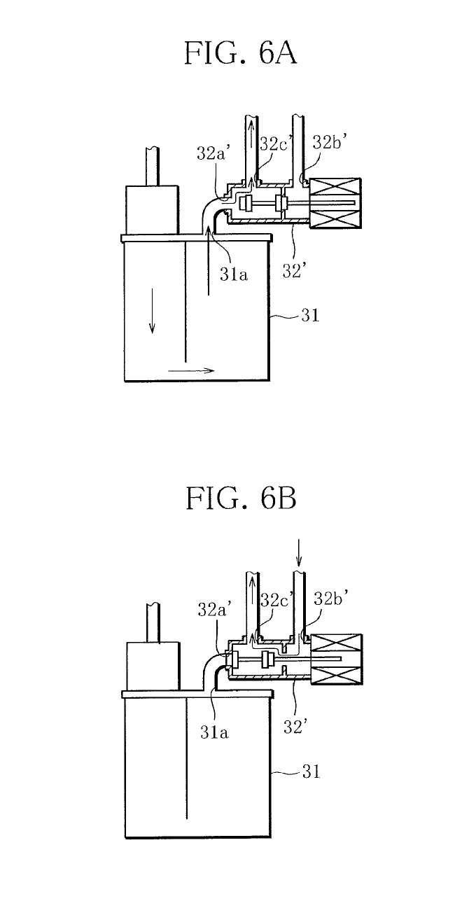

FIG. 5 schematically illustrates the configuration of the evaporative emission control device according to the third embodiment of the present invention. FIG. 6A is an enlarged view of a part A in FIG. 5 and illustrates an unoperated state of the canister shutoff valve 32′, FIG. 6B is an enlarged view of the part A in FIG. 5 and illustrates an operated state of the canister shutoff valve 32′, and in the figures, arrows indicate flowing directions of the fuel evaporative gas. In the following, the configuration of the evaporative emission control device for an internal combustion engine will be described.

As illustrated in FIGS. 5, 6A and 6B, the difference between the first and third embodiments resides in a fuel evaporative gas treatment section 30′.

The fuel evaporative gas treatment section 30′ includes the canister 31, the canister shutoff valve 32′, the fuel tank shutoff valve 33, the safety valve 34, the air filter 35, the evaporative gas reservoir 36, the purge control valve 37, the vapor line 38, and the purge line 39.

The canister shutoff valve 32′ has a canister connection port 32a′ for communicating with the evaporative gas passage hole 31a of the canister 31. The canister shutoff valve 32′ has a vapor line connection port 32b′ communicating with the vapor line 38, of which one end is connected to the leveling valve 27 of the fuel tank 21 and the other end is connected to the vapor line connection port 32b′, and also has a purge line connection port 32c′ communicating with the purge line 39, of which one end is connected to the intake passage 11 of the engine 10 and the other end is connected to the purge line connection port 32c′. Thus, the canister shutoff valve 32′ is connected through the vapor line connection port 32b′ to the vapor line 38 and is connected through the purge line connection port 32c′ to the purge line 39. The canister shutoff valve 32′ is a solenoid valve of which the valve element moves in such a manner that when the canister shutoff valve 32′ is de-energized, the canister connection port 32a′ and the purge line connection port 32c′ communicate with each other and that when the canister shutoff valve 32′ is energized with a drive signal externally supplied thereto, the vapor line connection port 32b′ and the purge line connection port 32c′ communicate with each other. That is, when the canister shutoff valve 32′ is de-energized, the fuel evaporative gas is allowed to flow out of the canister 31, as illustrated in FIG. 6A. On the other hand, when the canister shutoff valve 32′ is energized with the drive signal externally supplied thereto, the vapor line connection port 32b′ and the purge line connection port 32c′ are connected to each other, as illustrated in FIG. 6B, while the fuel evaporative gas is prevented from flowing into and out of the canister 31.

Thus, in the evaporative emission control device according to the third embodiment of the present invention, the communication between the intake passage 11 of the engine 10 and the canister 31 and the communication between the intake passage 11 of the engine 10 and the fuel tank 21 are switched by the canister shutoff valve 32′.

Accordingly, when the intake passage 11 of the engine 10 and the fuel tank 21 are connected to each other in order to lower the internal pressure of the fuel tank 21, the canister 31 is shut off, so that unnecessary adsorption of the fuel evaporative gas by the canister 31 can be prevented.

Also, since the communication between the intake passage 11 of the engine 10 and the canister 31 and the communication between the intake passage 11 of the engine 10 and the fuel tank 21 can be switched by means of a single solenoid valve, the control procedure can be further simplified.

What is claimed is:

1. A evaporative emission control device for an internal combustion engine, comprising:
a communication passage connecting an intake passage of the engine and a fuel tank to each other;
a canister configured to adsorb a fuel evaporative gas in the communication passage;
a communication passage opening-and-closing unit configured to establish and block communication between the communication passage and the intake passage;
a canister opening-and-closing unit configured to allow the canister to open into the communication passage and to shut off the canister;
a tank opening-and-closing unit configured to allow the fuel tank to open into the communication passage and to shut off the fuel tank; and
a pressure detector configured to detect an internal pressure of the fuel tank,
wherein, when the internal pressure of the fuel tank becomes higher than or equal to a predetermined value, the canister is shut off by the canister opening-and-closing unit.

2. The evaporative emission control device according to claim 1, wherein a state in which the communication passage opening-and-closing unit is opened and the tank opening-and-closing unit is closed and a state in which the communication passage opening-and-closing unit is closed and the tank opening-and-closing unit is opened are caused to repeatedly take place while the canister is shut off.

3. The evaporative emission control device according to claim 2, wherein the state in which the tank opening-and-closing unit is closed and the communication passage opening-and-closing unit is opened is caused to take place after the state in which the communication passage opening-and-closing unit is closed and the tank opening-and-closing unit is opened.

4. The evaporative emission control device according to claim 1, further comprising an evaporative gas reservoir inserted in a portion of the communication passage between the communication passage opening-and-closing unit and the canister opening-and-closing unit and configured to store the fuel evaporative gas.

5. The evaporative emission control device according to claim 2, further comprising an evaporative gas reservoir inserted in a portion of the communication passage between the communication passage opening-and-closing unit and the canister opening-and-closing unit and configured to store the fuel evaporative gas.

6. The evaporative emission control device according to claim 3, further comprising an evaporative gas reservoir inserted in a portion of the communication passage between the communication passage opening-and-closing unit and the canister opening-and-closing unit and configured to store the fuel evaporative gas.
